(19) United States
(12) Patent Application Publication
(10) Pub. No.: US 2005/0259839 A1
(43) Pub. Date: Nov. 24, 2005

(54) Construction for hearing devices or hearing aids

(75) Inventor: Bruno Gabathuler, Stafa (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/848,715

(22) Filed: May 19, 2004

(51) Int. Cl. H04R 25/00

(52) U.S. Cl. 381/322; 381/323; 381/324; 381/328

(57) ABSTRACT

The inventive casing construction for hearing devices or hearing aids respectively comprises a base plate (1) and casing shell detachable attached to said base plate (1), whereby the base plate (1) has one or more openings (2) arranged on its outside. Further on the base plate (1) comprising recesses or guidances (4) in the area of the openings (2) directed to the inside of the base plate (1) and further comprising at least one separate framework (3) insertable into said recesses or guidances (4) and connection means (8;9) to connect said framework (3) to the base plate (1). The attachment of the electronic and/or mechanic components within the device concerned is realized by the use of a framework (3), which may on one hand be optimized for the attachment purpose to enable a stable and durable connection for the components and on the other hand provides an optimized connection to the base plate (1) customized in material, colors or shapes.

### BACKGROUND OF THE INVENTION

This invention relates to a casing construction for hearing devices or hearing aids respectively with a base plate and casing shell detachable attached to said base plate, whereby the base plate has one or more openings arranged on its outside.

The present invention further relates to a hearing device or hearing aid with such a casing construction.

Electronic and mechanic components, such as amplifier electronics, microphones, loudspeakers and operating devices, of hearing devices or hearing aids respectively are commonly arranged within a housing or casing that comprises a base plate with a casing shell attached to it. The mechanical operating devices of those components are usually led through openings to the outside of the casing. A battery compartment to be closed by a cap is usually provided for the power supply of the electronic components with removable or replaceable batteries.

These electronic or mechanic components may be used for almost every kind or type of hearing devices or hearing aids, such as for behind-the-ear hearing aids as well as for in-the-ear hearing aids. For the latter especially high requirements are requested due to its restricted available space for the components. An economical production may yet be realized by the use of standardized components. As the external shape of such devices has to be adapted to the respective wearer of the devices, especially for in-the-ear hearing devices, the shape will be realized by individually shaped casing shells. Electronic or mechanic components will thereby be attached to the base plate of the device, which comprises at least one unified area for the receiving of such components.

Those components may not be attached in an optimal or reliable manner due to the material and the dimension of the casing shell and/or the base plate respectively, leading to early damages and/or defects of the device concerned. Especially the attachment of elements protruding to the outside, especially of movable caps for covering openings such as the battery cap of the battery compartment, is a problem and leads either to an accident sensitive and instable connection or to a stress of the electronic or other mechanic components, thus affecting the functionality of the device itself.

### SUMMARY OF THE INVENTION

It is an object of the present invention to provide a casing construction for hearing devices or hearing aids respectively, with a high flexibility of the design of the external shape and choice of material and/or color for the casing and reliably ensuring a stable connection or fitting of the electronic or mechanic components to be arranged inside the casing.

The present invention provides a casing construction for hearing devices or hearing aids respectively with a base plate and casing shell detachable attached to said base plate, whereby the base plate has one or more openings arranged on its outside and whereby the base plate comprising recesses or guidances in the area of the openings directed to the inside of the base plate and further comprising at least one separate framework insertable into said recesses or guidances and connection means to connect said framework to the base plate.

The attachment of the electronic and/or mechanic components within the device concerned is realized by the use of a framework, which may on one hand be optimized for the attachment purpose to enable a stable and durable connection for the components and on the other hand provides an optimized connection to the base plate customized in material, colors or shapes. A higher stability with regard to a direct connection of the components to the base plate may thus be achieved by choosing appropriate materials for the framework. The framework may further be used universally for different components and may thus be economically produced and used in large numbers.

In one embodiment, the framework consists of stiff plastic or metal and comprises recesses for the holding or passing through of electrical or mechanical components. The recess areas for the passing through of mechanical components or temporary electrically connections are exposed to high stress and may thus be strengthen by the framework. The stiff plastic may be designed to have as well good bonding qualities.

In another embodiment, the framework comprises at least one persistent recess with an axis or bridge overarching the recess. Movable or pivoting elements, such as caps or battery compartments, may be reliably attached or hold respectively by those axis or bridges. The forces acting onto those elements will be absorbed primarily by the framework and distributed transferred onto the base plate.

In a further embodiment, the axis or bridge consists of metal and is inserted or hold within a recess or bore of the framework. Such an axis may serve as a stable and strain proved axis of rotation for a cap.

In another embodiment, the front walls of the axis or bridge are directed towards the base plate in the inserted state of the framework within the base plate. Thereby, the front walls of the axis or bridge may be directed towards or abut the sidewalls of the recesses or guidances of the base plate. The axis in its assembled state is thus prevented from unintentional or independent loosening, but may nevertheless be pre-assembled within the framework.

In a further embodiment, the connecting means are bolted connection means. The connecting means may thereby comprise of a screw, passing through a respectively designed bore within the framework and insertable into a tap hole arranged at the bottom side of the base plate. The framework may thus easily be detachably connected to the base plate. A subsequent replacement of the framework may be easily performed by opening the device.

In another embodiment, the connecting means are built as snap-in means. Thereby, the snap-in means comprise of resiliently engaginq tongues arranged at the framework to engage into recesses arranged at the bottom side of the base plate. The framework thus may be connected to the base plate without the need of using any tools.

In a further embodiment, electrical contacting tongues are arranged at the framework. Those contacting tongues may be brought into resilient contact with a battery located in the area concerned for supplying power to the components of the device. The contacting tongues may as well be used to establish a connection for the programming of the electronic modules of the hearing device. Therefore, the contacting tongues concerned may be shifted back in relation to the other contacting tongues.

The present invention further provides a hearing device or hearing aid with such a casing construction with a base plate and a framework made out of different material.

A great advantage of this modular configuration lies in the fact that identical frameworks may be used for individually shaped, different base plates and casing shells. It is possible to replace an actually assembled framework by skilled service persons by another framework with new components and new contacting elements. The framework may be pre-assembled with the new components, resulting in an only short time need for the replacement itself.

### DESCRIPTION OF THE DRAWINGS

For purpose of facilitating and understanding of the invention, there is illustrated in the accompanying drawings a preferred embodiment thereof to be considered in connection with the following description. Thus the invention may be readily understood and appreciated.

FIG. 1 is a sectional view from above onto the area of the base plate of an inventive casing construction with the framework in its assembling position;

FIG. 2 is the view of a framework according FIG. 1;

FIG. 3 is a sectional view according FIG. 1 with the framework in its assembled position; and

FIG. 4 is a sectional view from below onto the framework in its assembling position.

### DESCRIPTION OF A PREFFERED EMBODIMENT

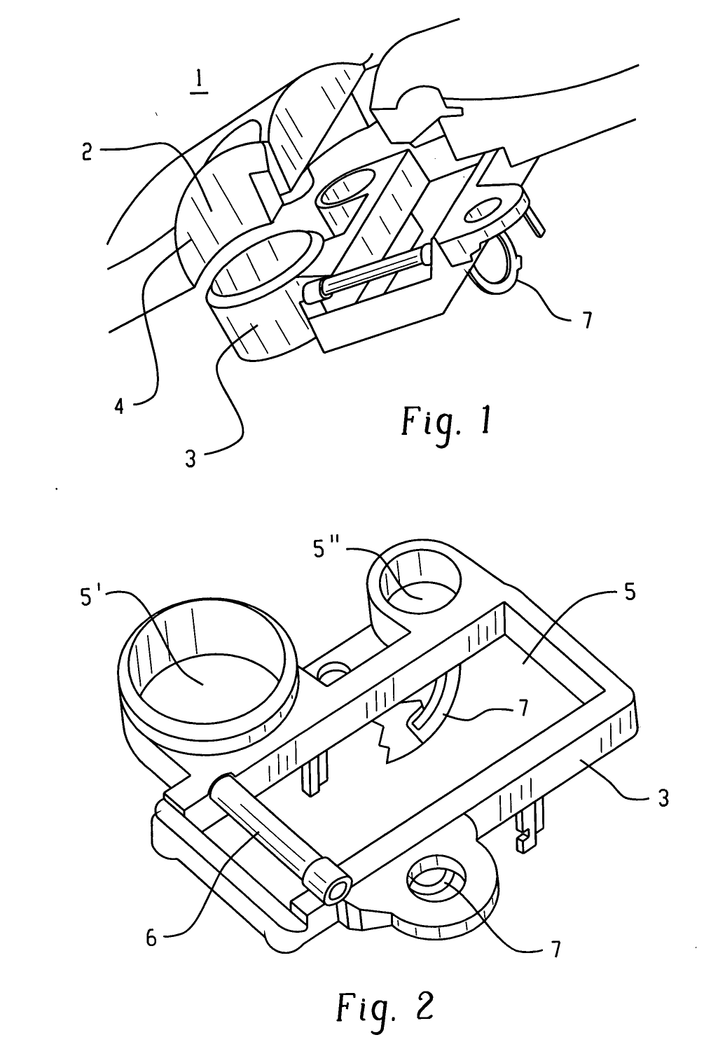

Referring to FIG. 1, the base plate 1 of a hearing device is shown with openings 2 leading to the outside. A framework 3 is arranged below the openings 2 on the inside of the hearing device, to be inserted into recesses or guidances 4 arranged below the openings 2.

The framework 3 consists of a stiff and form-stable plastic material having recesses 5, 5′ and 5″ respectively according to the opening 2 of the base plate 1, as shown in FIG. 2.

The recesses 5, 5′ and 5″ respectively are adapted to the openings 2 of base plate 1 or to the mechanical components of the hearing device determined to be put through the openings 2 or the recesses 5, 5′ and 5″ respectively.

For instance, a rectangular recess 5 with a pin 6 arranged across the opening 2 is provided. This pin 6 may serve as tilting axis for a cap provided as battery holder (not shown in the figure). By the suspension of the pin 6 within the framework 3 a stable and strain proved hinge for such a cap is realized. The forces acting onto such a cap will be first applied onto the framework 3 and only further on carried over to the base plate 1.

Electrical conducting tongues 7 may be provided at the framework 3 to be brought into contact with a battery or a programming plug (not shown) inserted into this area through the recess 5.

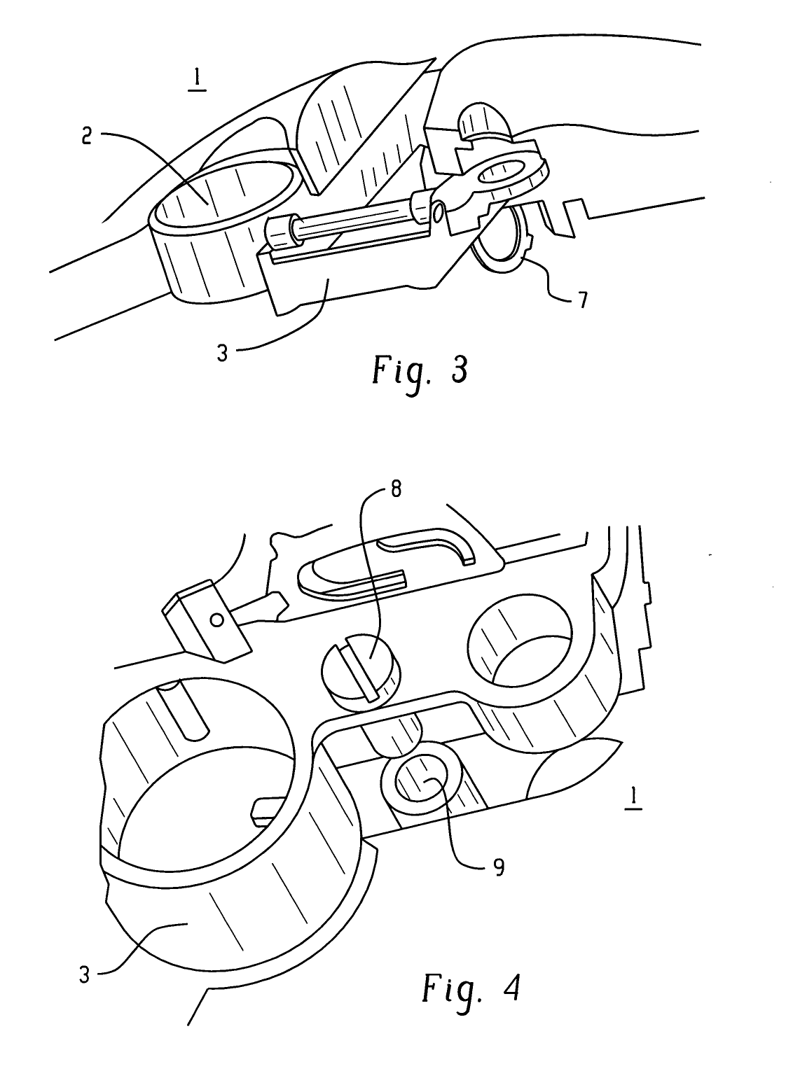

FIG. 3 is showing the framework 3 in its assembled final position within the base plate 1. The framework 3 is almost invisible from the outside due to its assembled position displaced to the bottom. The framework 3 may thus be realized in a discretionary standardized color, whereas the base plate 1 consists of an individual color scheme and/or material choice which will not be visible influenced by the framework 3.

FIG. 4 shows the view from below, e.g. from the inside of the casing of the hearing device, with a screw 8 as connecting mean for the framework 3 with the base plate 1. The screw 8 may be screwed into a tap hole 9 provided within the base plate 1, thereby ensuring a stable detachable connection.

It is clear for a person skilled in the art that the base plate 1 may as well be a part of a casing shell designed to functionally serve as base plate.

1. Casing construction for hearing devices or hearing aids respectively with a base plate (1) and casing shell detachable attached to said base plate (1), whereby the base plate (1) has one or more openings (2) arranged on its outside and whereby the base plate (1) comprising recesses or guidances (4) in the area of the openings (2) directed to the inside of the base plate (1) and further comprising at least one separate framework (3) insertable into said recesses or guidances (4) and connection means (8;9) to connect said framework (3) to the base plate (1).

2. Casing construction according claim 1, whereby the framework (3) consists of stiff plastic or metal and comprises recesses (5, 5′, 5″) for the holding or passing through of electrical or mechanical components.

3. Casing construction according claim 1, whereby the framework (3) comprises at least one persistent recess (5) with an axis or bridge (6) overarching the recess (5).

4. Casing construction according claim 3, whereby the axis or bridge (6) consists of metal and is inserted or hold within a recess or bore of the framework (3).

5. Casing construction according claim 3, whereby the front walls of the axis or bridge (6) are directed towards the base plate (1) in the inserted state of the framework (3) within the base plate (1).

6. Casing construction according claim 5, whereby the front walls of the axis or bridge (6) are directed towards or abut the sidewalls of the recesses or guidances (4) of the base plate (1).

7. Casing construction according claim 1, whereby the connecting means (8;9) are bolted connection means.

8. Casing construction according claim 7, whereby the connecting means (8;9) comprise of a screw (8), passing through a respectively designed bore within the framework (3) and insertable within a tap hole (9) arranged at the bottom side of the base plate (1).

9. Casing construction according claim 1, whereby the connecting means (8;9) are built as snap-in means.

10. Casing construction according claim 9, whereby the snap-in means comprises resilient engaging tongues arranged at the framework (3) to engage into recesses arranged at the bottom side of the base plate (1).

11. Casing construction according claim 1, whereby electrical contacting tongues are arranged at the framework (3).

12. Hearing device or hearing aid with a casing construction according to one of the claims 1 to 11 with a base plate (1) and a framework (3) made out of different material and/or color.
